(19) United States
(12) Patent Application Publication
(10) Pub. No.: US 2005/0022173 A1
(43) Pub. Date: Jan. 27, 2005

(54) Method and system for allocation of special purpose computing resources in a multiprocessor system

(75) Inventor: Udayan Rajendra Kanade, Maharashtra (IN)

Correspondence Address: William L, Botjer, PO Box 478, Center Moriches, NY, 11934, US

(73) Assignee: CODITO TECHNOLOGIES PRIVATE LIMITED, MAHARASHTRA (IN)

(21) Appl. No.: 10/667,757

(22) Filed: Sep. 22, 2003

Related U.S. Application Data
(60) Provisional application No. 60/474,381, filed on May 30, 2003.

(51) Int. Cl. G06F 9/44

(52) U.S. Cl. 717/140; 717/103; 717/120

(57) ABSTRACT

A method and system for allocating special-purpose computing resources in a multiprocessor system capable of executing a plurality of threads in a parallel manner is disclosed. A thread requesting the execution of a specific program is allocated a special-purpose processor with the requested program loaded on its local program store. The programs in the local stores of the special-purpose processors can be evicted and replaced by the requested programs, if no compatible processor is available to complete a request. The thread relinquishes the control of the allocated processor once the requested process is executed. When no free processors are available, the pending threads are blocked and added to a request-queue. As soon as a processor becomes free, it is allocated to one of the pending threads in a first-in-first-out manner, with special priority given to a thread requesting a program already loaded on the processor.

### BACKGROUND

The disclosed invention relates generally to processor allocation strategies in a computer having a multiprocessor environment. More specifically, it relates to a method and system for allocating special purpose computing resources to multiple threads in a multiprocessor system.

Rapid increases in computing power have conventionally been obtained by devising faster processors using high-speed semiconductor technology. Of late, however, multiprocessor systems have emerged as an alternative means for reducing application execution time and enhancing system performance.

A multiprocessor system comprises a computer architecture wherein multiple independent processing elements are provided for performing simultaneous computations. A task can thus be subdivided into a plurality of subtasks, each of which can then be executed by different processing elements in a parallel fashion. This results in higher performance and reduced makespan (the turnaround time for an application execution).

Optimization of the system performance critically requires an efficient processor scheduling strategy. An application for execution on a multiprocessor system is typically written as a series of interacting threads or subtasks. These threads constitute small program segments, which are then independently scheduled on various processors for execution by the operating system (OS). Once allocated, the thread is expected to run a program on the processor and then relinquish the processor back to the OS. This multithreading approach allows the OS to rapidly deploy a large number of smaller tasks on multiple processors and reassign them when the system's processing load changes. The OS needs to allocate these threads in a systematic fashion to optimize the performance and ensure maximum processor utilization.

Traditionally, a multiprocessor architecture used to include a plurality of general-purpose processors. Each of these processors would access a shared memory area. This is a symmetric multiprocessing (SMP) architecture since all the processors are symmetric and non-differentiable. The simplest strategy for processor allocation in such a system is the first-in-first-out (FIFO) methodology. When a job is requested for execution, it is processed by one of the free processors. In the event that no processor is free, the job is added to the tail of the job-queue. As soon as a processor finishes a job, it executes the job at the head of the job-queue. If there is no pending job, the processor goes into idle mode. The FIFO methodology is one of the various available strategies for process allocation in SMP. Several other strategies of varying complexity can be used, based on the knowledge of job time, task priority, job dependency etc. U.S. Pat. No. 6,199,093, titled “Processor Allocating Method/Apparatus In Multiprocessor System And Method For Storing Processor Allocating Program”, granted to NEC Corporation, Tokyo, Japan, discloses such a method. In this patent, computing resource allocation is based on a processor communication cost table that holds data communication time per unit data in sets of all the processors being employed.

However, the above-mentioned methodologies are only capable of handling processor allocation in simple multiprocessor configurations, where various processing elements are non-differentiable in their functionality. With increasing application complexity and performance constraints, there has come up a need for different types of processors that can perform specialized functions, and can be completely dedicated for performing certain specific computations only. The current state of the art offers, in addition to general-purpose processors, multiprocessor systems having special-purpose processing elements. These special-purpose processors have access to a limited amount of private storage area, also referred as local program store, for the instructions that would be executed on these processors. These processing elements can be classified according to the types of computations they are capable of performing. Examples include DSP processors, DMA engines, graphics processors, network processors and the like.

The local store of each of the special-purpose processors is filled with various programs. During the execution of an application, a thread can access a special-purpose processor from amongst a particular class for running a specific program. In the current methodology for processor allocation as described above, the programs are not changed or swapped during the running of an application. This proves to be a constraint in efficiently utilizing the capability of such multiprocessor systems. Besides, the processors need to be manually reprogrammed very often in order to facilitate execution of applications that have different processing requirements.

Another approach that can be applied to processor allocation is through application of the standard caching methodology to manage local program stores. Caching operates by automatically storing memory addresses to frequently requested data. Requests to a large slow memory can then be made via a small fast memory that stores these addresses. This improves the execution time of a request. The system needs to periodically manage the addresses that are to be kept and those that are to be removed. Commonly used techniques for cache updation include FIFO, least-recently-used, least-frequently-used etc. This is quite similar to allocation of special-purpose processors. When a request for allocation comes, a processor with the requested program loaded on it should be returned. The allocation strategy will have to manage the programs that need to be kept in the program stores of the processors and those that are to be removed periodically. The algorithms used for caching and cache updation can, thus, be applied to special-purpose processor allocation, by equating a processor local store to a cache line and the program to an item.

The caching approach, however, is not very efficient for processor allocation. A memory request to the cache is momentary in nature. On the contrary, in case of processor allocation, the processor remains busy for some time. During this period, it cannot be used to serve requests for the same program by another thread. In case multiple threads are requesting the same program, the strategy would prove inefficient since one program will be loaded onto only one processor at a time. Besides, a single processor can accommodate more than one program at a time. This strategy does not utilize this capability.

In light of the foregoing discussion, it is clear that improved processor allocation strategies are required for automating the task of allocating and managing special-purpose processors. An optimal setting of programs should be managed in the processors to fully utilize their efficiency in a non-symmetric multiprocessor environment. It is desired that the processors need to be reprogrammed minimally while the application has a fixed pattern of program requests. In case of applications where the pattern of programs requested changes over time, it is desired that the processors' allocation patterns change to adapt to the request pattern. Processor allocation strategies need to be better suited to the fact that a processor remains busy serving a particular request for a finite amount of time. Besides, they must utilize the processors' capability to store and manage multiple programs simultaneously.

### SUMMARY

The disclosed invention is directed to a method and system that facilitates efficient allocation of special-purpose processors in a non-symmetric multiprocessor system.

An object of the disclosed invention is to provide a method and system that automates the task of allocating and managing special-purpose processors in a multiprocessor system to minimize frequent reprogramming.

A further object of the disclosed invention is to provide an optimal setting of programs in the local program stores of special-purpose processors in order to fully utilize their efficiency and reduce the application execution time.

Yet another object of the disclosed invention is to improve upon the commonly used first in first out (FIFO) processor allocation strategy in order to minimize program swaps in the local program stores of special-purpose processors.

Still another object of the disclosed invention is to provide a program-aware processor allocation methodology, which allocates processors based on the processing load requirements of the application.

In order to attain the above-mentioned objectives, a method for automated allocation of special-purpose processors to different application segments in a multiprocessor environment is provided. An application running on the system is written as a series of interacting threads, each of which is capable of running an application segment. The application is compiled via a compilation service. Each special-purpose processor can access a limited private storage area (or the local program store). The local program stores contain programs that can perform specific functions. The operating system also provides a processor allocation service to coordinate the allocation of processors to different threads to optimally distribute processing load across the processors.

A thread interested in running a specific program requests the allocation service for allocation of a processor with the requested program loaded on its local program store. If such a processor is currently available with the system, it is allocated to the thread. However, if none of the currently available processors have the requested program loaded on their local program stores, then prior to allocation, an instance of the requested program needs to be loaded onto the local program store of one of the free processors. This may require removal of one or more originally stored program instances. Various strategies are used for eviction of program instances from the local program store. If no processor is available to complete the request, the requesting thread is blocked and added to the tail of a request queue.

When a special-purpose processor is relinquished back to the processor allocation service, the service can allocate it to one of the blocked threads. Such allocation is done on a priority basis, with precedence given to a thread that requests allocation of a program already stored on the relinquished processor. This results in “program-aware” processor allocation. The number of processors a program is loaded on becomes approximately proportional to the frequency of requests for that program. Moreover, the programs automatically get loaded onto the processors in such a fashion that programs that are not likely to be requested together get loaded on the same processor. On the other hand, the programs that are likely to be requested together get loaded on separate processors. As a result, there is a substantial reduction in number of program swaps in the local program stores after an initial transient period.

### BRIEF DESCRIPTION OF THE DRAWINGS

The preferred embodiments of the disclosed invention will hereinafter be described in conjunction with the appended drawings provided to illustrate and not to limit the disclosed invention, wherein like designations denote like elements, and in which:

FIG. 1 is a schematic representation of the environment in which the processor allocation method operates, in accordance with an embodiment of the disclosed invention;

FIG. 2 is a block diagram that schematically illustrates the architecture of a multiprocessor system comprising special-purpose processors;

FIG. 3 is a logic flow diagram that illustrates the basic steps of processor allocation process in a multiprocessor system;

FIG. 4 is a flowchart that illustrates the sequence of steps for allocating a special-purpose processor to a thread requesting a specific program, in accordance with a preferred embodiment of the disclosed invention;

FIG. 5 is a flowchart that illustrates the process steps for allocation of a processor once it is relinquished after completion of a task, in accordance with a preferred embodiment of the disclosed invention; and

FIG. 6 is a flowchart that illustrates the entire sequence of process steps for allocation of special-purpose computing resources to individual threads during the execution of an application in a multiprocessor system.

### DESCRIPTION OF PREFERRED EMBODIMENTS

A method and system for allocating special purpose computing resources in a multiprocessor system are disclosed. Typically, large applications are executed in a multiprocessor system via multiple sub-tasks or threads independently scheduled on different computing resources or processors. The disclosed invention provides automation of the task of allocating and managing different processors in a non-symmetric multiprocessor environment.

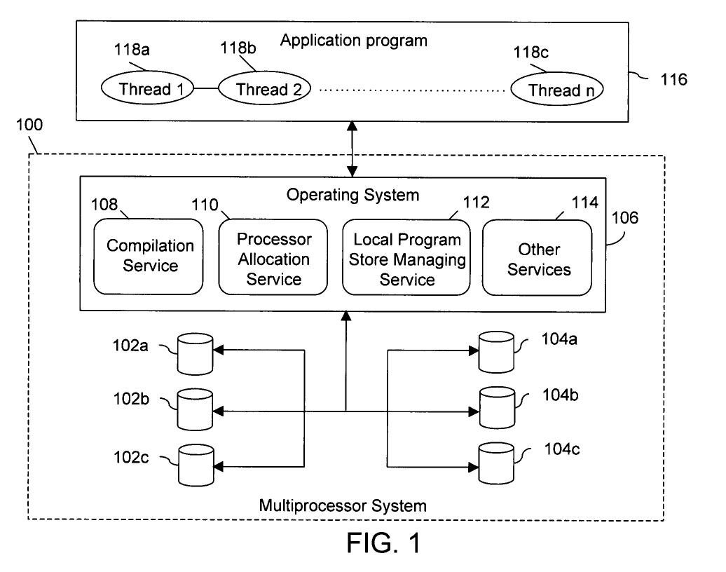

Referring primarily to FIG. 1, the environment in which the processor allocation methodology operates, in accordance with an embodiment of the disclosed invention, is hereinafter described. A multiprocessor system 100 constitutes a plurality of computing resources including some general-purpose processors 102, and some special-purpose processors 104. Each general-purpose processor 102 accesses a shared memory area. General-purpose processors 102 and special-purpose processors 104 may be different in their functionality and the nature of computations that they can perform. Hence, multiprocessor system 100 is non-symmetric in nature. The processors are controlled by an operating system (OS) 106. OS 106 provides compilation service 108, processor allocation service 110, and local program store managing service 112, in addition to other services 114. An application program 116 running on OS 106 is written as a series of interacting threads 118, each scheduled to perform a sub-task. The application program is compiled by compilation service 108. Upon loading, threads 118 send requests to processor allocation service 110 for allocation of processors to them. The requests from threads 118 to processor allocation service 110 constitute a processing load on processor allocation service 110. Processor allocation service 110 synchronizes allocation of individual processors to threads 118 for complying with the processing load.

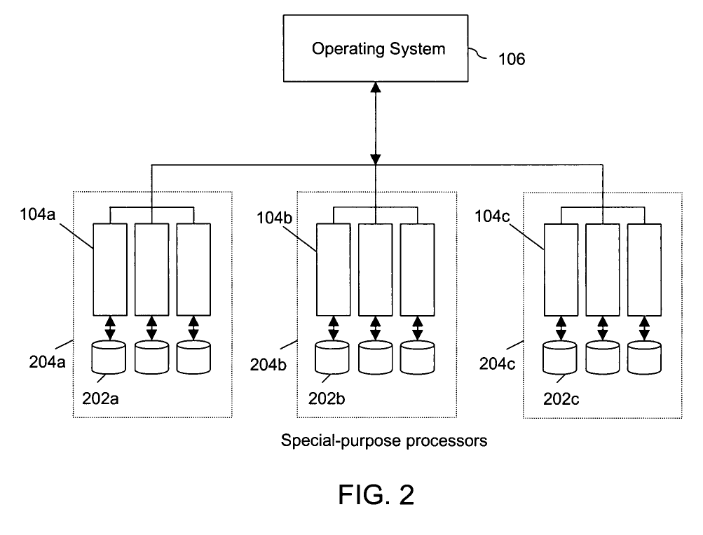

Referring now primarily to FIG. 2, the architecture of a multiprocessor system comprising special-purpose processors 104 is hereinafter described. Each special-purpose processor 104 can access only a limited amount of private storage area 202 for the instructions that it is supposed to execute. Storage area 202, also referred to as a local program store, is loaded with a plurality of specific programs. The kind of programs stored on the local stores, differentiate the special-purpose processors. During the execution of an application, the individual threads are allocated a special-purpose processor depending upon the program that the thread has requested. These processors can be further divided into classes 204 depending upon the kind of computations they can perform. Hence, all the processors belonging to a particular class are expected to cater to similar kinds of processing requests. Processor allocation service 110 synchronizes the allocation of all processors belonging to a particular class. Local program store managing service 112 manages the programs that need to be kept in local program stores at a particular instant and the ones that are to be evicted. Processors belonging to different classes are controlled via OS 106 through processor allocation services specific to various classes of the processors.

The processor allocation methodology of the disclosed invention is not restricted to application programs written using threads. It would be evident to one skilled in the art that the invention is equally applicable to any requesting entity that needs access to a shared processor resource. Examples of such requesting entities include processes, agent objects or users running specific tasks. Hereinafter, the term thread implies any requesting entity requesting access to the shared processor resources.

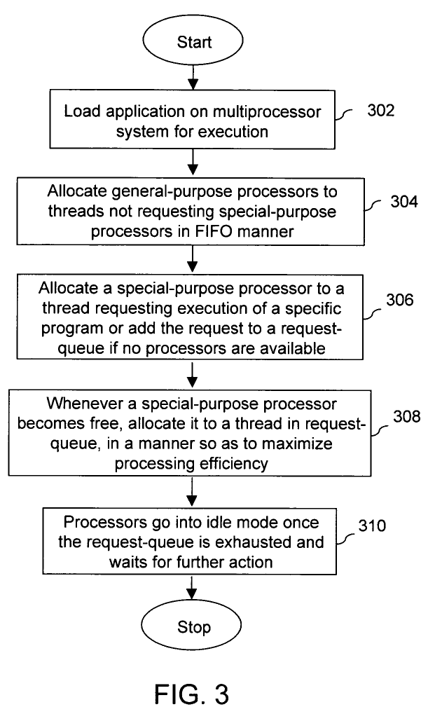

Referring now primarily to FIG. 3, the basic steps of processor allocation process in multiprocessor system 100 are hereinafter described. At step 302, application program 112, written as a series of interacting threads 114, is loaded on compilation service 108 for compilation. The individual threads are then allocated to different processors as per the processing request, by processor allocation service 110. Certain threads do not require any specific processes to be performed on one of the special-purpose processors. Such a thread is allocated one of the free general-purpose processors 102 at step 304. This allocation can be done using a first-in-first-out (FIFO) strategy wherein a free processor receives the first thread request from the request-queue. It would be evident to one skilled in the art that more complex strategies could also be used for processor allocation based on knowledge of parameters like task execution time, task priority, task pending time and task dependency. Examples include priority based preemptive scheduling (based on the knowledge of task priority), worst bottleneck based scheduling algorithms (based on task dependencies) etc.

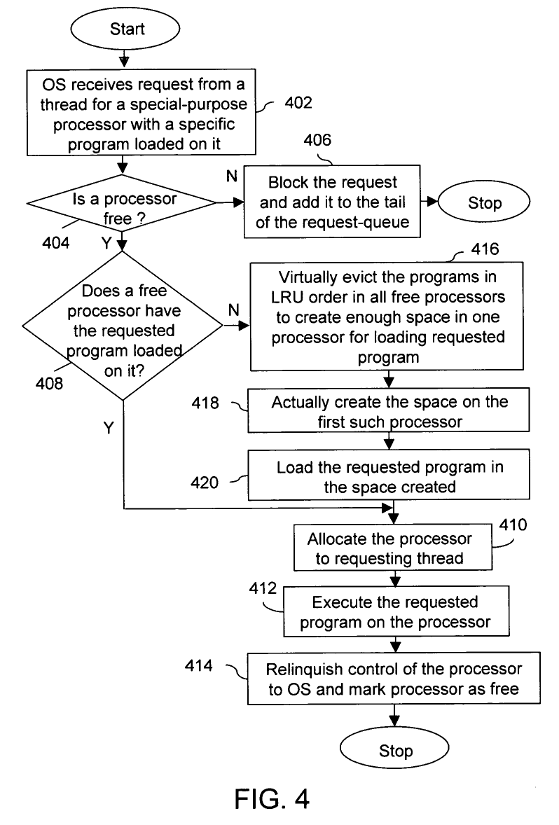

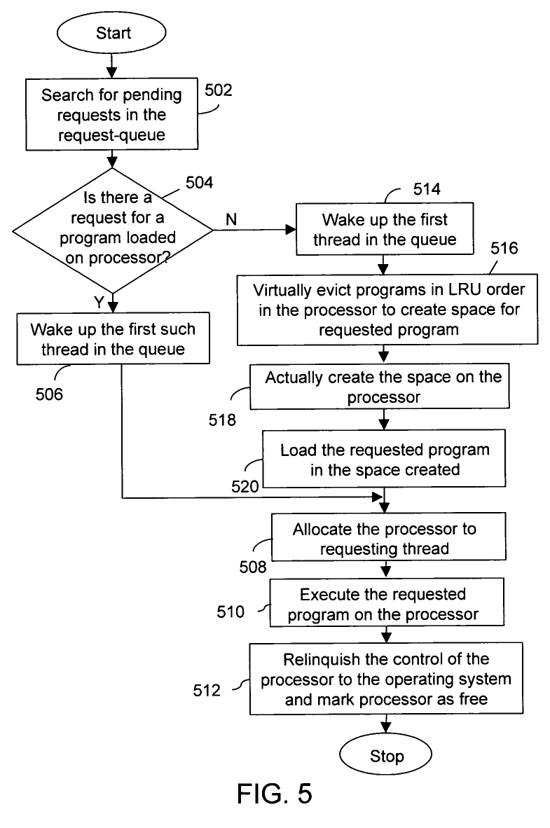

A thread that requests execution of a specific program is allocated a special-purpose processor 202 from a pool of same-class special-purpose processors 204, at step 306. The thread may itself be running on a general-purpose processor and request execution of a specific program. Such a thread would temporarily switch from the general-purpose processor mode to the special-purpose processor mode. Once the requested program has been executed, the thread may switch back to the general-purpose processor mode, or request another special-purpose processor. The step of processor allocation is further elaborated upon, with the help of FIG. 4. The thread runs the requested program instance on the processor allocated to it. After complete execution of the program, the thread relinquishes the processor back to processor allocation service 110. At step 308, as soon as the thread releases the control of special-purpose processor 104, it is allocated to one of the other pending threads in the request-queue. This allocation is done in a manner that maximizes the processing efficiency of the multiprocessor and is explained in detail with reference to FIG. 5. Finally, at step 310, the processor goes into idle mode after the request-queue has been exhausted. The exhaustion of the request-queue implies that there are no more pending requests at that moment.

Referring now primarily to FIG. 4, the sequence of steps for allocating special-purpose processor 104 to a thread requesting a specific program, in accordance with a preferred embodiment of the disclosed invention is described. At step 402, the OS receives a request for the control of a processor with a specific program loaded on it. In one embodiment, the requesting thread can be running on a general-purpose processor, and temporarily switches to the special-purpose processor mode for execution of a specific program. In response to the thread's request, at step 404, processor availability is determined by processor allocation service 110. If no processors are free to execute the request, the thread is blocked and added to the tail of a request-queue that holds other such pending requests, in accordance with step 406. However, if any of the processors is free then at step 408, processor allocation service 110 further checks whether any of the currently available processors has the requested program instance already loaded on its local program store 202. If such a processor is available, it is allocated to the requesting thread at step 410. At step 412, the processor allocated at step 410 executes the requested program instance. At step 414, the processor is relinquished back to processor allocation service 110 once the requested program has been executed. It is also marked free and added to the pool of free processors.

Following is an exemplary pseudo-code that illustrates the call sequence that a thread might perform.

handle = spp_get (program_A);
setup (handle, data);
spp_run (handle);
spp_release (handle);

The spp_get 0 function instructs the OS to allocate a processor with program_A loaded onto it. The spp_get ( ) call is executed once the processor allocation service 110 allocates a special-purpose processor. The handle ( ) contains information about which processor has been allocated, and where in the local program store is program_A loaded. After the processor is allocated, the thread may set up the processor for the requested program to be run. This may include setting up memory, stacks, parameters, constants, tables, data structures etc., which are necessary for running the program. The spp_run ( ) function call runs the requested program on the allocated processor. After the program finishes running, the spp_release ( ) call releases the allocated processor to be used by another thread. The above function call names are just representative of the kind of application program interface (API) that an OS implementing the invention would provide. Moreover, the sequence and the exact manner of implementing these calls are variable and depend upon the way a thread has been programmed. For instance, the spp_run ( ) call might be called more than once, after a single spp_get ( ), possibly with varying parameters.

In case none of the free processors have the requested program instance loaded on their local program stores 202 at step 408, the program needs to be loaded onto local program store 202 of one of the free processors. This is done by local program store managing service 112. In order to load the requested program instance on local program store 202, one or more of the originally loaded programs may need to be removed to create enough space for the program to be loaded. Next, at step 416, programs stored on local stores of all free processors are virtually evicted in least-recently used (LRU) order, until a space large enough to fit the requested program is created on one of the processors.

The LRU methodology removes programs from the local program stores in the chronological order of their usage. In other words, a program that has been allocated by processor allocation service 110 least recently would be removed first, followed by other programs in that order. Programs, which have been recently used, would be sustained in the local program stores as far as possible. Once a processor with enough space to fit in the program instance is found, the programs in its local store are actually evicted to create the requisite space for loading the program in accordance with step 418. The process of eviction comprises deleting the programs or OS data structures lying in the “hole”. The program instances evicted from the local program store are termed as victim programs. The virtual eviction step ensures that multiple program instances are not unnecessarily removed from various free processors. During virtual eviction, a set of prospective victim programs is identified on each of the free processors. Once a processor with enough space to fit in the requested program instance is identified, the actual eviction occurs only on that processor. In this manner, programs on other processors are not unnecessarily evicted. Besides, even on the same processor, only a requisite number of programs are made victims depending upon their size, so that the requested program instance may fit in. In other words, not all prospective victim programs identified on a processor need to be removed in case eviction of only some of the existing programs may fit in the requested program instance.

At step 420, the requested program instance is loaded onto the processor and the processor is then allocated to the requesting thread at step 410. The thread may, in addition to running the program, also perform certain other activities like data transfer. As soon as the thread completes the execution of the program and other thread specific logic, it releases control of the processor back to processor allocation service 110, as already explained.

It would be evident to one skilled in the art that the LRU program eviction scheme used in the above methodology for choosing the victim programs can be replaced by any other suitable strategy such as FIFO, least-frequently-used or other heuristics as suited for different applications, without deviating from the scope of the disclosed invention. The FIFO strategy would remove programs serially in the order in which they were initially loaded on the local program store. In other words, the oldest program on the local program store would be removed first, followed by the other more recent programs. The least-frequently-used strategy removes the least frequently used programs first. Thus, it tends to retain the most requested programs and evict the least requested ones on the local program stores.

Referring now primarily to FIG. 5, the process steps for allocation of a processor once it is relinquished after completion of a task, in accordance with a preferred embodiment of the disclosed invention, are hereinafter described. At step 502, processor allocation service 110 searches for any pending requests in the request-queue. If there is any pending thread requesting for any program already loaded on the free processor at step 504, the first such thread is given priority over other threads in the queue. At step 506, this thread is activated for execution. This thread is preferentially allocated the processor at step 508. At step 510, the processor executes the requested program instance. After execution of the requested program instance, the thread relinquishes the control of the processor back to processor allocation service 110, in accordance with step 512. However, at step 504, if there is no pending request in the queue that requires a program already loaded on the processor, the processor allocation is made in serial order. In other words, the first thread in the request-queue is given the control of the processor.

Next, at step 514, the first thread in the queue is activated for execution. However, prior to the allocation of the processor to the thread, the program instance requested by the thread needs to be loaded on the local program store of the processor. This is done by local program store managing service 112. At step 516, program instances stored in the local program store of the processor are virtually evicted in LRU order until enough space to fit the requested program has been created. Next, the hole thus created is actually evicted of all the programs currently lying in that hole, at step 518. The requested program instance is loaded in the space created on the processor at step 520 and the processor is allocated to the requesting thread. Once the thread completes the execution of the program, it releases the control of the processor back to processor allocation service 110. The processor is marked as free and added to the pool of free processors.

The allocation strategy used in the above methodology is a modification of the FIFO strategy. As soon as a processor becomes free, the first thread that it is allocated to is either the first thread on the request-queue or the first thread on the queue requesting for an already loaded program. In an alternative embodiment of the disclosed invention, the processor allocation scheme can be augmented using information on parameters like task priority, task execution time, task pending time and program relevance as explained earlier. The OS running processor allocation service 110 can automatically gather such information. It would be evident to one skilled in the art that the LRU program eviction scheme used in the above methodology can be replaced by any other suitable strategy such as FIFO, least-frequently-used or other heuristics, as suited for different applications.

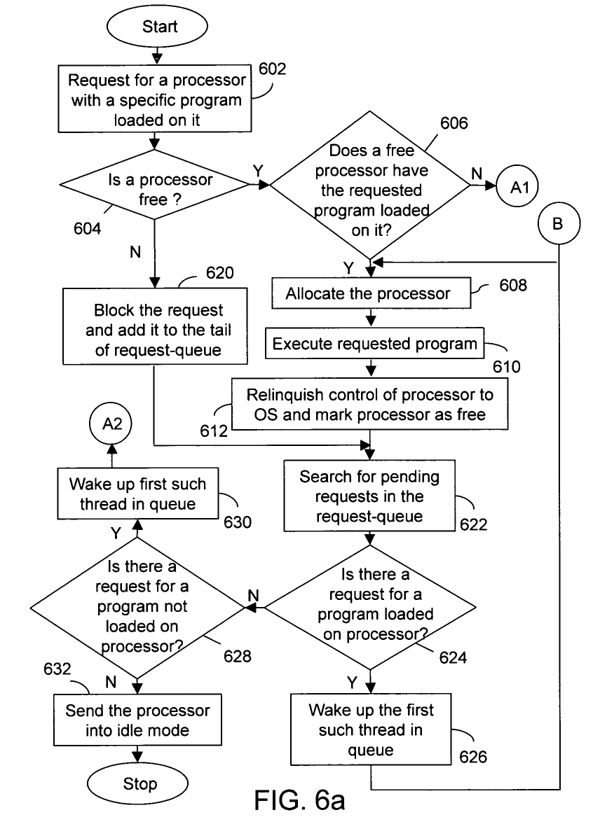

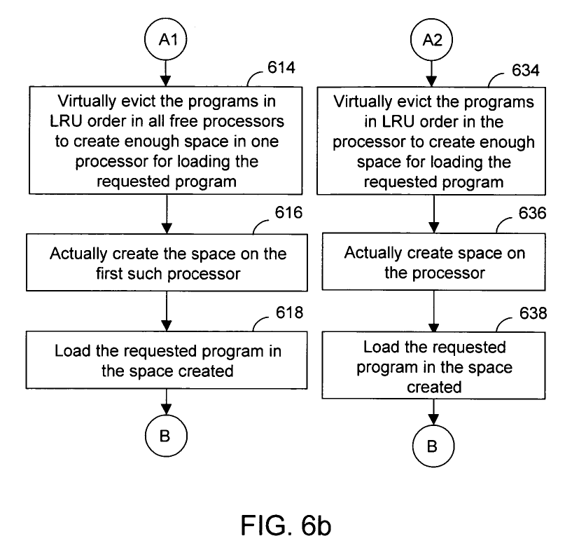

Referring now primarily to FIG. 6, the entire sequence of process steps for allocation of special-purpose computing resources to individual threads, during the execution of an application in a multiprocessor system, is hereinafter described. At step 602, a thread interested in running a particular program requests processor allocation service 110 for allocation of a processor with the particular program loaded on it. The thread may itself be running on a general-purpose processor and temporarily may switch from the general-purpose processor mode to the special-purpose processor mode. If such a processor is currently available with the system, it is allocated to the thread, in accordance with steps 604 to 608. In response to the thread's request, at step 604, processor availability is determined by processor allocation service 110. If any of the processors is free then at step 606, processor allocation service 110 further checks whether any of the currently available processors has the requested program instance already loaded on its local program store 202. If such a processor is available, it is allocated to the requesting thread at step 608.

The thread relinquishes control of the processor back to allocation service after running the program at step 610, in accordance with step 612. If none of the processors currently available have the requested program loaded onto them, then the requested program needs to be loaded onto one of them in the manner as already described with the help of FIG. 4. This is done in a sequence of steps 614, 616 and 618. In order to load the requested program instance on local program store 202, one or more of the originally loaded programs may need to be removed to create enough space for the program to be loaded. At step 614, programs stored on local stores of all free processors are virtually evicted in least-recently used (LRU) order, until a space large enough to fit the requested program is created on one of the processors. Once a processor with enough space to fit in the program instance is found, the programs in its local store are actually evicted to create the requisite space for loading the program in accordance with step 616. At step 618, the requested program instance is loaded onto the processor and the processor is then allocated to the requesting thread at step 608.

If no processor is available to complete an allocation request, the thread is blocked and added to a request-queue, in accordance with step 620. When a special-purpose processor is relinquished back to processor allocation service 110, the service can allocate it to one of the blocked threads in the request-queue. This allocation is done on a priority basis, with special preference given to a thread that requests allocation with a program already loaded on the processor. This methodology has already been explained in detail in conjunction with FIG. 5, and occurs in accordance with steps 622 to 638.

At step 622, processor allocation service 110 searches for any pending requests in the request-queue. If there is any pending thread requesting for any program already loaded on the free processor at step 624, the first such thread is given priority over other threads in the queue. At step 626, this thread is activated for execution. This thread is preferentially allocated the processor at step 608.

However, at step 624, if there is no pending request in the queue that requires a program already loaded on the processor, it is further checked whether there is a request for a program not loaded on the processor at step 628. If not, then it implies that there are no more pending requests. Hence, the processor is sent into idle mode at step 630. However, in case there are pending requests for programs not stored on the processor, then processor allocation is made in serial order. In other words, the first thread in the request-queue is given the control of the processor. At step 632, the first thread in the queue is activated for execution.

However, prior to the allocation of the processor to the thread, the program instance requested by the thread needs to be loaded on the local program store of the processor. This is done by local program store managing service 112. At step 634, program instances stored in the local program store of the processor are virtually evicted in LRU order until enough space to fit the requested program has been created. Next, the hole thus created is actually evicted of all the programs currently lying in that hole, at step 636. The requested program instance is loaded in the space created on the processor at step 638 and the processor is allocated to the requesting thread. Once the thread completes the execution of the program, it releases the control of the processor back to processor allocation service 110. The processor is marked as free and added to the pool of free processors.

The inventive methodology described above provides a number of advantages over the existing processor allocation methodologies. The disclosed method has the ability to manage local program stores of special-purpose processors, during the execution of an application. This renders application programming more flexible. The conventional systems do not have an evolved methodology for providing this feature. The programs stored in local program stores cannot be changed during an application runtime. Thus, a lot of free processor time is wasted due to mismatch between the programs that a processor has stored in its local store, and the requests made by the individual threads. The local stores need to be reprogrammed each time an application is to be executed, in accordance with the anticipated requirement for various programs. The inventive method disclosed in this patent application automates local program store management and removes the need for reprogramming the local stores frequently.

The following example further elaborates this feature. Suppose a parallel application consisting of many threads such as a parallel DSP application, which uses Fast Fourier Transforms (FFTs) and convolution, needs to be executed. Conventionally, the allocation of the processors to these threads and balancing their performance would need to be done manually. This can be quite cumbersome, because if the performance of one of the processes were improved, there would be no overall improvement until the processor allocation is “re-matched”. Using the disclosed invention, the rebalancing happens automatically. Hence, the performance of the FFTs can be improved without manually matching their performance to those of the convolution.

The disclosed invention uses a “program aware” processor allocation strategy. This strategy is an improvement over the FIFO strategy. FIFO is essentially a “program unaware” strategy since it allocates a free processor to the first thread in the request queue, irrespective of the program requested by the thread. This results in many program swaps from the local program stores of the processors, in order to comply with thread requests. The “program aware” strategy of the disclosed method allocates a free processor on priority basis, giving preference to a thread that requests a program already loaded on the free processor. The program aware strategy makes the number of processors a program is loaded on, approximately proportional to the frequency of requests for that program. Moreover, the programs automatically get loaded onto the processors in such a fashion that programs that are not likely to be requested together get loaded on the same processor. On the other hand, the programs that are likely to be requested together get loaded on separate processors. As a result, there is a substantial reduction in number of program swaps in the local program stores after an initial transient period. This may automatically result in reduced makespan i.e. execution time for an application.

Furthermore, for applications where the pattern of programs requested changes over time, the above method can adapt with the changing pattern, and manage an optimal setting of programs in the special-purpose processors.

The advantages of the program aware strategy can be further explained with the help of an example. Suppose there are four special-purpose processors in a multiprocessor system. The application being executed is such that there are two programs being asked for all the time, program A and program B. The total computational bandwidth required by A is thrice that required by B, and the two programs cannot fit together in the local program store. Using the disclosed method, the system will subsequently converge to loading three processors with A and one with B. Moreover, later the incumbent circumstances may cause a change in required computational bandwidth. For instance, if A and B require the same computational bandwidth, the system will converge to a new stable point with A and B on two processors each. Once this state is reached, there would be no more movement of programs required, because in this configuration all the processors will always find work for which they are programmed. In other words, the requesting threads would promptly find processors that can complete their allocation request.

The disclosed invention is also an improvement over the existing caching strategies because it can put more than one program on a single processor and one program on more than one processor. This results in better utilization of local program stores. Processor allocation requests are also non-momentary in nature. In other words, these requests take a finite period for execution during which the processor resource cannot be used to cater to other requests. The disclosed method is also better suited to such non-momentary requests.

It would be evident to one skilled in the art that the above methodology is not only applicable to special-purpose processor allocation in a non-symmetric multiprocessor environment, it is equally applicable to any other processor that can access a private program storage.

While the preferred embodiments of the disclosed invention have been illustrated and described, it will be clear that the invention is not limited to these embodiments only. Numerous modifications, changes, variations, substitutions and equivalents will be apparent to those skilled in the art without departing from the spirit and scope of the disclosed invention as described in the claims.

1. A method for managing allocation of processors in a non-symmetric multiprocessor system, the multiprocessor system comprising a plurality of general-purpose processors and a plurality of special-purpose processors, each special-purpose processor having access to a local program store, the local program store being loaded with specific programs, the method comprising the steps of:
a. compiling an application program in response to a request for execution of the application program, the application program comprising a plurality of interacting threads, each of the plurality of threads being capable of independently executing an application segment;
b. scheduling the plurality of threads on various general-purpose processors and special-purpose processors based on the availability of the processors and the type of request; and
c. managing the local program stores of each of the special-purpose processors for complying with processing load, the processing load being dependent on the requests for specific programs and the frequency of such requests.

2. The method as recited in claim 1 further comprising the step of forming a request-queue, the request queue storing all the stalled threads that have not been allocated a special-purpose processor, the stalled threads waiting for allocation of the special-purpose processors.

3. The method as recited in claim 2 wherein the step of scheduling the plurality of threads comprises the steps of:
a. allocating a free general-purpose processor to a thread that does not request access to any special programs, the special programs being stored on local program stores of the special-purpose processors;
b. allocating a free special-purpose processor to a thread requesting access to a special program, the special program being stored in the local program store of the special-purpose processor being allocated; and
c. stalling the requesting thread and adding it to the tail of the request-queue, if no free processors are available.

4. The method as recited in claim 3 wherein the thread requesting access to a specific program loaded on a special-purpose processor is itself running on a general-purpose processor, the thread temporarily switching from the general-purpose processor mode to the special-purpose processor mode.

5. The method as recited in claim 3 wherein the step of allocating a free special-purpose processor comprises the steps of:
a. receiving an allocation request from a thread for a processor with a specific program loaded on its local program store;
b. searching for a free special-purpose processor with the requested program already loaded on its local program store;
c. allocating the free special-purpose processor with the requested program already loaded on its program store to the requesting thread, if such a processor is available; and
d. loading the requested program on the local program store of a free special-purpose processor and allocating it to the requesting thread, if no free special-purpose processor is available with the requested program already loaded on it.

6. The method as recited in claim 1 wherein the step of managing the local program stores comprises the steps of:
a. preferentially allocating a free special-purpose processor to a thread that requests access to a program already loaded on the local program store of the special-purpose processor; and
b. evicting the existing programs on the local program store of a free special-purpose processor until a space large enough to fit a specific program is created, in response to a request for a specific program not stored in the local program store of the special-purpose processor being allocated to the thread.

7. A method for allocating special-purpose processors in a multiprocessor computer system running an application, the application comprising a plurality of threads, each special-purpose processor having access to a local program store, the threads requesting access to special programs, the special programs having been stored on the local program stores of the special-purpose processors, the method comprising the steps of:
a. receiving an allocation request from a requesting thread for a special-purpose processor with a special program loaded on its local program store;
b. allocating a special-purpose processor with the requested program loaded on its local program store to the requesting thread, if a free special-purpose processor is available;
c. stalling the requesting thread and adding it to a request-queue, if no free special-purpose processors are available;
d. checking the request-queue for any pending requests, once a special-purpose processor is released by the requesting thread;
e. allocating the free special-purpose processor to the first thread in the request-queue that requests for a program already loaded on the processor;
f. allocating the free special-purpose processor to the first thread in the request-queue, if none of the threads in the request-queue request for a program already loaded on the processor; and
g. receiving the control of the allocated processor from the requesting thread, once the processor becomes idle.

8. The method as recited in claim 7 wherein the step of allocating a special-purpose processor with the requested program loaded on its local program store to the requesting thread, if a free special-purpose processor is available, comprises the steps of:
a. searching for a free special-purpose processor with the requested program already loaded on its local program store;
b. allocating the free special-purpose processor with the requested program already loaded on its local program store to the requesting thread, if such a processor is available; and
c. loading the requested program on the local program store of a free processor and allocating it to the requesting thread, if no free special-purpose processor is available with the requested program already loaded on its local program store.

9. The method as recited in claim 8 wherein the step of loading the requested program comprises the steps of:
a. virtually evicting the programs on the local program stores of all the free special-purpose processors until a processor with enough space on its local program store to fit the requested program is identified;
b. creating the space by actually evicting programs on the local program store of the identified special-purpose processor;
c. loading the requested program in the space created on the special-purpose processor; and
d. allocating the processor to the requesting thread.

10. The method as recited in claim 9 wherein the step of virtually evicting the programs from the local stores of free special-purpose processors is carried out in least-recently-used order, least-frequently-used order or first-in-first-out order.

11. The method as recited in claim 9 wherein the step of virtually evicting the programs from the local stores of free special-purpose processors further comprises the use of task information while creating space on the processor, the task information being information regarding task priority, task execution time, task pending time and program relevance.

12. The method as recited in claim 7 wherein the step of allocating the special-purpose processor to the first thread in the request-queue, if none of the threads in the request-queue request for a program that is already loaded on the local program store of the special-purpose processor, comprises the steps of:
a. virtually evicting the programs on the local program store of the special-purpose processor to create enough space for fitting in the requested program;
b. creating the space for fitting in the requested program on the processor by actually evicting the programs;
c. loading the requested program in the space created on the processor; and
d. allocating the processor to the requesting thread.

13. The method as recited in claim 12 wherein the step of virtually evicting the programs from the local store of the special-purpose processor is carried out in least-recently-used order, least-frequently-used order or first-in-first-out order.

14. The method as recited in claim 12 wherein the step of virtually evicting the programs from the local program store of the special-purpose processor further comprises the use of task information while creating space on the processor, the task information being information regarding task priority, task execution time, task pending time and program relevance.

15. The method as recited in claim 7 wherein one or more of the steps is embodied in a computer program product.

16. A system for managing allocation of processors in a non-symmetric multiprocessor environment, the multiprocessor comprising a plurality of general-purpose processors and a plurality of special-purpose processors, each special-purpose processor having access to a local program store, the system comprising:
a. a compilation service for compiling an application program in response to a request for execution of the application program, the application program comprising a plurality of interacting threads;
b. a processor allocation service for scheduling and synchronizing the plurality of threads on various general-purpose processors and special-purpose processors; and
c. a local program store managing service for managing the local program stores of each of the special-purpose processors for complying with processing load.

17. The system as recited in claim 16 wherein the processor allocation service comprises:
a. means for allocating a free general-purpose processor to a thread that does not request access to any special programs, the special programs being stored on the local program stores of special-purpose processors;
b. means for allocating a free special-purpose processor to a thread requesting access to a special program, the special program being stored on the local program store of the processor being allocated; and
c. means for stalling the requesting thread and adding it to the tail of the request-queue.

18. The system as recited in claim 16 wherein the local program store managing service comprises:
a. means for preferentially allocating a free special-purpose processor to a thread that requests access to a program already loaded on the local program store of the special-purpose processor; and
b. means for evicting the existing programs on the local program store of a free special-purpose processor until a space large enough to fit a specific program is created.
